(19) United States
(12) Patent Application Publication
(10) Pub. No.: US 2002/0012730 A1
(43) Pub. Date: Jan. 31, 2002

(54) METHOD OF IMPARTING AN ULTRA-SHORT, MOMENTANEOUS HEAT TREATMENT TO A LIQUID

(75) Inventors: JENS MOURITS SORENSEN, VIRUM (DK); CARSTEN OLE RASMUSSEN, GLOSTRUP (DK)

Correspondence Address: SUGHRUE MION ZINN MACPEAK & SEAS, 2100 PENNSYLVANIA AVENUE NW, WASHINGTON, DC, 200373202

(73) Assignee: JENS MOURITS SORENSEN

(21) Appl. No.: 08/983,464

(22) PCT Filed: Dec. 22, 1997
(86) PCT No.: PCT/DK97/00589

(51) Int. Cl. A23C 3/02

(52) U.S. Cl. 426/511; 426/580; 426/521

(57) ABSTRACT

In a method of providing a brief heat treatment to a liquid by mixing steam therein followed by flash cooling at reduced pressure, very short and easily adjustable holding time at elevated temperature is obtained by adjustable increase of the amount of steam injected into the liquid to amounts exceeding those which condense by contacting the liquid. The method is efficient for heat treatment, such as sterilization, of heat sensitive materials including food products of high viscosity.

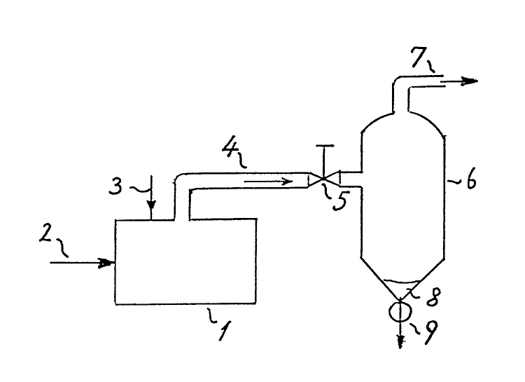

### FIELD OF THE INVENTION

The present invention relates to heat treatment of heat sensitive liquids by steam injection. The heat treatment may have different purposes such as complete or partial sterilization or stabilization of liquid food products or pharmaceuticals, or stripping of volatile components from the liquid.

### BACKGROUND OF THE INVENTION

When applying a heat treatment to heat sensitive materials it is often advantageous to apply a relatively high temperature for a short period in preference to using a more prolonged treatment at lower temperature. Thus, when the desired beneficial effect of the heat treatment, for instance destruction of microorganisms and their germs, is enhanced to a greater extent by raise of temperature than the heat damage is increased by such a raise, it can be advantageous to perform the heat treatment at relatively high temperature avoiding an increased heat damage by substantially shortening the time period in which the material is at elevated temperature.

This principle is utilized i.a. in the socalled UHT processing of milk with a view of obtaining a long shelf-life at ambient temperature.

For a more detailed explanation of prior art technology within this field reference is made to H. Burton: Ultra-High-Temperature Processing of Milk and Milk Products (Elsevier Applied Science Publishers Ltd., 1988). Also Ullmann's Encyclopedia, 5th ed. (1988), Vol. A 11, pages 549-552, discusses UHT sterilizing of milk and explains how various combinations of heating time and temperature influence microbial spores destruction, vitamin destruction, enzyme deactivation, protein denaturation and color changes.

In UHT processes the increase of temperature is achieved by using indirect heaters or direct heaters in which steam is contacted with and condenses into the liquid to be treated.

When exploiting the present invention, only direct steam heating comes into consideration as heating system, because a very rapid temperature increase is crucial as evident from the below description of the invention. Besides, the indirect heating principle is less suitable for liquids of high viscosity.

Typically UHT processing of milk comprises a heating step in which the milk is contacted with steam, followed by passage through a retention or holding zone to a flash cooling step wherein a momentaneous evaporative cooling takes place.

In the heating step direct contact between the liquid and steam takes place in a mixing zone.

From the mixing zone the liquid passes through a holding zone decisive for the duration of the heat treatment and which is important for a uniform treatment of all parts of the liquid.

In the literature referred to above as well as in Encyclopedia of Food Science, Food Technology and Nutrition, pages 2305-2313, 1993, it is emphasized that the holding zone at all times during operation must be completely filled with liquid. This means that the amount of steam introduced in the mixing zone must not exceed the amount which condenses therein.

From the holding zone the liquid passes through a restricting means creating a substantial pressure drop, and the liquid reaches a chamber of lower pressure wherein a momentaneous evaporation takes place, whereby the liquid is cooled to a temperature at which it is not subjected to any heat damage.

The vapours formed by this evaporation are withdrawn to a condenser, usually supplied with heat-regeneration means, and the non-evaporated part of the liquid is recovered from the bottom portion of the chamber as a marketable product or as an intermediate for further processing.

It is important that a vigorous mixing of steam into the liquid takes place in the mixing zone, especially when the liquid to be treated is of high viscosity, such as concentrates of milk and other food products. Equipment suitable for this purpose is described in Applicant's published International Patent Applications WO 94/13395 and WO 96/22830, incorporated herein by reference.

The apparatus described in said two International Patent Applications is of the type having a disc-shaped rotor in a housing into which the steam injection is carried out in a limited zone above the rotor at a distance from both the circumference and the centre of the rotor. This type of apparatuses enables very fast heating of even high-viscosity liquids, within the dairy industry it is known as a Niro LSI™ apparatus.

It is a drawback of the above described prior art processes that the minimum time period, in which the liquid is at maximum temperature cannot be reduced as much as desired. In the period necessary for the liquid to pass through the holding zone, the liquid is near or at the maximum temperature. Passage through such a zone having a certain volume has hitherto usually been regarded as important for obtaining the desired results. Moreover, constructional features restrict the possibilities of decreasing said volume. Further, processing conditions such as the acceptable pressures and thus temperatures set limits as to the velocity at which the liquid can be forced through the holding zone when the processing is performed as described above.

### SUMMARY OF THE INVENTION

It is an object of the invention to provide a method for heat treatment of a liquid by direct steam heating, by which method it is possible to adjustably reduce the time period in which the liquid, is at maximum temperature and at the same time obtain an efficient heat treatment of all parts of the liquid.

We have now found that the above object and other advantages may be obtained by mixing an amount of steam into the liquid in the mixing zone greater than the amount which condenses in the heating step. Thereby the non-condensed steam will partly displace the liquid from the holding zone and decrease the residence time thereof in said zone. Surprisingly this decrease of residence time can be obtained without impairing the function of the holding zone as a means for securing an efficient heat treatment.

Consequently, the invention deals with a method of imparting an ultra-short, momentaneous heat treatment to a liquid by mixing steam into a stream of said liquid in a mixing zone, passing the stream of liquid through a holding zone and, after passage of a pressure controlling restricting means, subsequently into a flash cooler, which method is characterized in that the amount of steam mixed into the stream of liquid, is larger than the one which condenses by contacting the liquid, whereby the non-condensed portion of the steam serves to obtain passage of the liquid through the holding zone with reduced residence time therein compared with the residence time obtained in the same holding zone if only the amount of steam that condenses by contacting the liquid had been used.

The method is not restricted to the use of any specific apparatus for forming the mixing zone, but it is essential that a quick and efficient mixing of the liquid and the steam is obtained using only a very short residence time for the liquid in the zone.

As an example of an apparatus suitable for creating the mixing zone is the Niro LSI™ apparatus described above. Obviously a prolonged residence time in the mixing zone after contact with steam has started would prevent obtainment of the above specified object of the invention.

The holding zone may encompass a separate unit or vessel, but it may also be a part of the same apparatus which creates the mixing zone and/or be formed in pipes and other equipment connecting the mixing zone with the restricting means.

As restricting means an adjustable valve may suitably be used which enables maintenance of a pressure in the mixing zone and the holding zone corresponding to the maximum temperature desired in the liquid. In case a non-adjustable restricting means such as an orifice plate is used said pressure can of course be obtained by adjusting the amounts of steam and liquid introduced into the mixing zone.

Downstream of the restricting means the pressure is sufficiently low, below or above atmospheric pressure, to ensure a flash cooling of the liquid by evaporation. The surplus of steam, which reaches the flash cooling step, is withdrawn to the condenser together with the vapour created by the momentaneous evaporation of part of the heated liquid.

By the process according to the invention it is possible to reduce the residence time for the liquid at the maximum temperature to less than 1/100 of what has been possible with the prior art direct steam heating processes where all steam is condensed before leaving the mixing zone.

### BRIEF DESCRIPTION OF THE DRAWING

The sole FIGURE on the drawing diagrammatically shows a flow-chart of an embodiment of the method according to the invention.

### DETAILED DESCRIPTION OF PREFERRED EMBODIMENTS

On the drawing a mixing zone is represented by 1. This may typically be formed by a Niro LSI™ apparatus or other equipment enabling a similar fast mixing of steam and liquid. The liquid to be treated is fed to the mixing zone through a conduit 2 and steam is provided through conduit 3. The steam is introduced in an amount corresponding to the maximum temperature at which it is desired to heat the liquid, adjusted to compensate heat loss in the equipment. The steam may be superheated, but typically its temperature is only little above the saturation temperature or at the saturation temperature.

It is an essential feature of the method according to the invention that the amount of steam introduced through 3 is in excess of the minimum amount required to obtain the desired heating, that means the amount of steam introduced is higher than the amount which condenses by contacting the liquid.

In the embodiment depicted the liquid after being heated and diluted by the water created by steam condensation therein passes into a pipe 4 which, together with the exit part of the equipment forming the mixing zone 1 constitutes a holding or retention zone. Also the non-condensed portion of the steam introduced through 3 passes from the mixing zone into the holding zone in pipe 4.

The liquid as well as the surplus of steam leaves the pipe 4 through a valve 5. In a preferred embodiment this valve may be adjusted to provide a back pressure suitable for maintaining the desired conditions in 1 and 4.

That part of the steam, which is not condensed, as well as the heated liquid pass from valve 5 into a flash cooler 6 where a pressure substantially below the one residing in the holding zone in pipe 4 causes a momentaneous evaporation, whereby that part of the liquid which does not evaporate is cooled to a temperature typically not far from the temperature at which the liquid were introduced through conduit 2.

The vapour formed by this evaporation together with the non-condensed steam introduced through 5 is withdrawn through a duct 7 to a condenser (not shown) for pressure control.

The liquid cooled by the evaporation collects in the bottom portion 8 of the flash cooler from where it is recovered, suitably by means of a pump 9.

Adjustment according to the invention of the amount of steam led to the system through conduit 3 forms a very convenient and efficient way of adjusting the total residence time of the liquid at elevated temperature. By increasing said amount sufficiently it is possible to reduce the time period from the liquid contactes the steam in 1 to the liquid passes valve 5 for flash cooling to only a small fraction of the corresponding time period if no surplus of steam were used.

When it is desired to heat the liquid at a temperature above 100° C., for example when sterilizing milk products at approximately 150° C. in 1/100 sec., the pressure in 1 and 4 will be over-atmospheric.

If on the other hand the maximum temperature is below 100° C. an under-atmospheric pressure exists in the mixing zone and the holding zone.

In the following important fields of application are summarized.

Especially when the mixing zone has moving, agitating mechanical means to ensure a rapid and efficient dispersion of the steam into the liquid, as is the case f.inst. by the Niro LSI™ apparatus, the liquid to be treated can be a high viscous food product, preferably concentrate of milk or of a milk fraction or a fractionated or whole egg product, which is subjected to the heat treatment with a view of reducing the contents of microorganisms or microorganisms spores.

Typically such heat treatment may preceed a spray drying or other processing of the liquid food product.

The liquid can f.inst. be a concentrate of baby-food or of milk or milk fractions with or without addition of other components such as sugar, such products having a dry solids content of 40-75% by weight and the steam temperature is then above 110° C., preferably 120-160° C. and the amount of steam is adjusted to obtain a residence time for the liquid at that temperature of 0.5 sec. or less, preferably 0.01-0.2 sec.

By such a treatment the amount of germs of Bacillus cereus can be reduced from 10⁶/ml to below 100/ml without heat damage of the product. This means that the taste is not impaired in any substantial way, and the Solubility Index (SI) is not unacceptably increased. For instance for the heat treatment of a whole milk concentrate the SI can be kept below 0.2 ml, typically below 0.1 ml. The SI is measured at a dry solids contents of 13% by weight according to ADMI.

In the present specification and the attached claims the term milk is intended to cover whole milk as well as skim milk.

When treating a liquid comprising egg yolk or egg white or both, the maximum temperature is preferably only 65-70° C. for a period less than 0.5 sec., preferably of 0.01-0.2 sec. to avoid coagulation of the product. However, with suitable additives it is possible to use higher temperatures.

Examples of other products suitable for being treated by the method according to the invention, either as such or as concentrates, are coffee whiteners, fruit juices, sweetened condensed milk and icecream mixes.

The method may be used for liquids in the shape of solutions, emulsions, dispersions, suspensions og slurries, for instance within the food and drink industry or the pharmaceutical and cosmetical industry.

The method may also find application when the liquid to be treated contains a compound more volatile than the other components thereof, in which case the treatment involves a removal of a substantial part of the volatile component by stripping thereof. Thus the method may be used to reduce the contents of alcohol in a fermented brewerage while maintaining an acceptable taste and flavour thereof.

In the following the method according to the invention is further illustrated by means of comparison and embodiment examples.

### Comparison Example

This comparison Example as well as the embodiment Examples 1 and 2 below were performed in a plant corresponding to the one described above in connection with the drawing. For mixing the liquid to be treated and the steam a Niro LSI™ apparatus was used. A sensor was inserted in the holding zone to measure the maximum temperature achieved by the liquid being treated.

The comparison comprised two runs. The starting material for both was a whole milk concentrate having a dry solids contents of 47% by weight and at an initial temperature of 65° C.

The amount of steam led to the mixing zone corresponded to the one which, based on theoretical calculations (including heat loss to the equipment), would condense completely when heating the liquid to the below specified temperatures.

Before the heat treatment spores of Bacillus cereus were added to the milk concentrate to obtain a concentration of such spores of 2.7×10⁶/ml.

After the treatment the concentrate was cooled to 65° C. in the evaporative cooler, and the concentration of remaining spores of Bacillus cereus was measured. Said concentration is indicated below as CFU/ml, meaning “Colony Forming Units per ml”.

In these runs where the holding zone was completely filled with liquid, an approximate residence time for said liquid in the holding zone can be calculated to 1 sec.

Details from these two runs appear from the below Table:

| | Run 1 | Run 2 |
|---|---|---|
| Concentrate flow, l/h | 132 | 128 |
| Steam flow, kg/h | 14 | 16 |
| Steam pressure, bar | 3.7 | 3.7 |
| Steam temperature, ° C. | 141 | 141 |
| Maximum liquid temperature, ° C. | 110 | 120 |
| Spore concentration | 9.0 × 10³ | <1.0 × 10²* |
| after the heat treatment, CFU/ml | | |

*The method used to determine the spore concentration comprised dilution of the concentrate necessitated by the high viscosity thereof. This dilution implied that the minimum spore concentration to be recorded as the result of this determination method is <1.0 × 10², even if no colony forming units were found.

By visual and organoleptic evaluation of the treated product this was found acceptable, but determination of the solubility index according to ADMI, measured at a dry solids contents of 13% by weight, revealed that the product treated at a maximum temperature of 120° C. had a SI of 0.4. Preferably, this index should be below 0.2.

### Example 1

This Example was carried out using the same equipment as used in the above Comparison Example.

A whole milk concentrate having a dry solids contents of 47% by weight was heat treated from an initial temperature of 65° C. to the various maximum temperatures indicated in the below Table. As it also appears from said Table when compared with the above Comparison Example, steam was used in an amount substantially exceeding the amount corresponding to complete condensation.

Before the heat treatment spores of Bacillus cereus were added to obtain a total concentration thereof of 1.2×10⁶ CFU/ml.

After the treatment the concentrate was cooled to 65° C. in conventional manner in the evaporative cooler.

The various parameters as well as the concentration of spores after the treatment were as follows:

| | Run 1 | Run 2 | Run 3 | Run 4 | Run 5 |
|---|---|---|---|---|---|
| Concentrate flow, l/h | 123 | 131 | 125 | 122 | 133 |
| Steam flow, kg/h | 22 | 25 | 27 | 29 | 33 |
| Steam pressure, bar | 2.0 | 2.2 | 2.4 | 2.6 | 3.0 |
| Steam temperature, ° C. | 120 | 123 | 125 | 129 | 133 |
| Maximum liquid | 118 | 121 | 123 | 127 | 131 |
| temperature, ° C. | | | | | |
| Spore concentration | 2.0 × | 8.5 × | 7.2 × | 2.0 × | <1.0 × |
| after the heat treat- | 10⁵ | 10³ | 10² | 10² | 10² |
| ment, CFU/ml | | | | | |

As explained in the Comparison Example above the result of the spore concentration analysis indicated as <1.0×10² reflects the fact that actually no colony forming spores were revealed by propagation.

The treated milk concentrates did not show any kind of burning, discolouration or destruction of other functional properties. The solubility index after heat treatment at 131° C. was 0.1. when determined by using the same method as in the above Comparison Example.

### Example 2

Also in this Example the material to be treated was a whole milk concentrate having a dry solids contents of 47% by weight and at an initial temperature of 65° C. The same equipment was used as in the above Comparison Example and in Example 1.

Before treatment spores of Bacillus stearothermophilus were added to obtain a concentration thereof of 1.4×10⁴/ml. After the treatment the concentrate was cooled to 65° C. in the evaporative cooler.

The various parameters of the method and the spore concentrations after the heat treatment appear from the following Table:

| | Run 1 | Run 2 |
|---|---|---|
| Concentrate flow, l/h | 142 | 140 |
| Steam flow, kg/h | 37 | 45 |
| Steam pressure, bar | 4.3 | 5.2 |
| Steam temperature, ° C. | 147 | 153 |
| Maximum liquid temperature, ° C. | 146 | 152 |
| Spore concentration | 7.4 × 10³ | <1.0 × 10² |
| after the heat treatment, CFU/ml | | |

It is remarkable that even when the test organism, the very heat stable Bacillus stearothermophilus, is used as test organism, a substantially complete spore destruction is obtained in Run 2. This result was obtained without any kind of burning, discolouration or other destruction of functional properties, and the solubility index after the heat treatment at 152° C. (measured as above) was only 0.1. This surprising result is due to the fact that the surplus of steam used in this Example is substantially above the amount which condensates by contact with the concentrate in the mixing zone. This will be evident by comparing the various parameters with those of the above Comparison Example.

1. A method of imparting an ultra-short momentaneous heat treatment to a liquid by mixing steam into a stream of said liquid in a mixing zone, passing the stream of liquid through a holding zone and after passage of a pressure controlling restricting means subsequently into a flash cooler, characterized in that the amount of steam mixed into the stream of liquid is larger than the one which condenses by contacting the liquid, whereby the non-condensed portion of the steam serves to obtain passage of the liquid through the holding zone with reduced residence time therein compared with the residence time obtained in the same holding zone if only the amount of steam that condenses by contacting the liquid had been used.

2. A method according to claim 1, characterized in that the mixing zone has moving, agitating mechanical means to ensure a rapid and efficient dispersion of the steam into the liquid.

3. A method according to claim 1 or 2, characterized in that the liquid is a viscous food product, preferably a concentrate of milk or milk fractions with or without addition of other components such as sugar, or a fractionated or whole egg product, which is subjected to the heat treatment with a view of reducing the contents of microorganisms or microorganism spores.

4. A method according to claim 1 or 2, characterized in that the liquid is fresh milk for consumption.

5. A method according to claim 3 in which the liquid is a concentrate of baby food or milk or a milk product, with or without addition of other components such as sugar, such products having a dry solids contents of 40-75% by weight, and wherein the temperature of the steam is above 110° C., preferably 120-160° C., and the amount of steam is adjusted to obtain a residence time for the liquid at that temperature of 0.5 sec. or less.

6. A method according to claim 1 or 2, wherein the liquid is a non-dairy food product.

7. A method according to claim 3 wherein a liquid comprising egg yolk or egg white or both is heated at 65-70° C. for a period less than 0.5 sec.

8. A method according to claim 1 or 2 wherein the heat treatment is performed on a liquid containing a component more volatile than the other components thereof and the treatment is made to remove a substantial part of said volatile component by stripping thereof.

9. A method according to claim 8 wherein the liquid is a fermented brewerage from which a content of alcohol is reduced by stripping during the treatment.
